(19) United States
(12) Patent Application Publication
(10) Pub. No.: US 2018/0046438 A1
(43) Pub. Date: Feb. 15, 2018

(54) METHODS FOR MANAGING THE LIFE CYCLE OF A CLOUD APPLICATION USING A PLURALITY OF CLOUD INFRASTRUCTURES

(71) Applicant: FASTCONNECT, ISSY LES MOULINEAUX (FR)

(72) Inventors: Luc BOUTIER, FONTAINEBLEAU (FR); Gauvin GIRAULT, LE PLESSIS PATE (FR)

(21) Appl. No.: 15/528,593

(22) PCT Filed: Nov. 12, 2015
(86) PCT No.: PCT/FR2015/053054

§ 371 Date: Sep. 13, 2017

(30) Foreign Application Priority Data
Nov. 21, 2014 (FR) 14 61315

(51) Int. Cl. G06F 9/44; G06F 9/445

(52) U.S. Cl. CPC G06F 8/10; G06F 8/65

(57) ABSTRACT

Some embodiments are directed to a collaborative platform for managing the life cycle of a cloud application, the collaborative platform including means configured to define, in the form of code, a plurality of requirements of the cloud application, in terms of cloud infrastructures.

### CROSS REFERENCE TO RELATED APPLICATION(S)

This application is a national phase filing under 35 C.F.R. §371 of and claims priority to PCT Patent Application No. PCT/FR2015/053054, filed on Nov. 12, 2015, which claims the priority benefit under 35 U.S.C. §119 of French Patent Application No. 1461315, filed on Nov. 21, 2014, the contents of each of which are hereby incorporated in their entireties by reference.

### BACKGROUND

Some embodiments are directed to the methods for managing the life cycle of a Cloud application deployed over several Cloud infrastructures.

“Cloud computing” allows a dynamic workload to be sustained with an elastic provision of resources in order to respond to the precise requirements of an application. The Cloud is therefore considered as an economical solution in that the user is only charged for whatever resources are consumed. As a result, the Cloud technologies are experiencing a growing success offering an increasingly diversified solution, giving rise to a landscape of multi-provider and varied Clouds.

However, the idea is to be able to move an application and/or a service with the corresponding workload between various public and/or private Clouds. This movement allows an application, its data, its dependences, together with the associated workload being executable within a Cloud infrastructure “A”, to be migrated across a network toward another Cloud infrastructure “B”. More generally, the portability in Cloud computing is the capacity to move a workload from one Cloud provider to another, without needing significant modifications within the application or within its context.

The portability of workloads from one Cloud to another may be motivated by various arguments such as:
avoiding the syndrome of exclusive dependency on a single Cloud provider;
taking advantage of a better price and/or of a better quality of service offered by another Cloud infrastructure;
a single Cloud cannot generally satisfy all the needs of a client (for example, a reliable and resilient Cloud infrastructure, economically advantageous, which covers several geographical regions and which offers the best quality of service).

This question of portability of the workload was the subject of a standard TOSCA (for “Topology and Orchestration Specification for Cloud Applications”). Therefore, the movement of a workload from one Cloud infrastructure to another is implemented possible so that an application may be deployed, simultaneously or successively, over a plurality of Cloud infrastructures.

However, such a portability of Cloud applications requires a certain agility to be taken into account not only in the development of these applications, but also in their deployment throughout their life cycle. This agility must allow the teams responsible for their development and for their exploration to maintain the Cloud applications throughout their life cycle (for example, integration of new functions/features, updates, adaptation to a particular Cloud infrastructure). More generally, lifecycle management for the Cloud applications, which may be moved from one Cloud infrastructure to another, is required.

### SUMMARY

Some embodiments facilitate the design and the portability, according to the TOSCA standard, of Cloud applications.

Some embodiments render the development and upgrade of the Cloud applications independent of the technologies and of the deployment infrastructures so as to allow the integration of any later version of a Cloud application into any existing infrastructure and deployment layer.

Some embodiments accelerate the design of the Cloud applications infrastructures and to improve the re-use of the resources.

Some embodiments promote and to facilitate the collaboration between the developers and the operational teams (in other words, the deployment teams) in the creation of the components and of the architectural planes of the Cloud applications throughout the life cycle of these applications.

Some embodiments allow the integration of the

Cloud applications with the existing systems via the API REST (REpresentational State Transfer) and automatic installation methods (pluggable).

Some embodiments facilitate the portability/migration of a Cloud application across several Cloud computing infrastructures with the minimum of effort.

Some embodiments relate, according to a first aspect, to a collaborative platform for managing the life cycle of a Cloud application, this collaborative platform including means configured for defining in the form of code a plurality of requirements, in terms of Cloud infrastructure, of the Cloud application.

This platform is configured for integrating a development functionality in order to supply the Cloud application with functionalities.

For these purposes, some embodiments provide, according to a second aspect, a method for managing the life cycle of a Cloud application, this method including a first step for defining, in the form of code, a plurality of requirements, in terms of Cloud infrastructure, of the Cloud application, and a second step for receiving by a collaborative platform the definition, in the form of code, of the said plurality of requirements.

Advantageously, the definition of the requirements is implemented in a TOSCA format.

According to a third aspect, the some embodiments relate to a computer program product stored on a memory media, capable of being implemented within a data processing unit and including instructions for the implementation of the method summarized hereinabove.

Other aims and advantages of the embodiments will become apparent from reading the description of embodiments, presented below with reference to the appended FIG. 1 which illustrates schematically one embodiment for managing the life cycle of a Cloud application.

### BRIEF DESCRIPTION OF THE FIGURES

FIG. 1 shows a collaborative platform 10 for managing the life cycle of an application deployed in one or more Cloud infrastructure(s). The management of the life cycle of a Cloud application is aimed at the creation and the maintenance of this Cloud application throughout its life cycle.

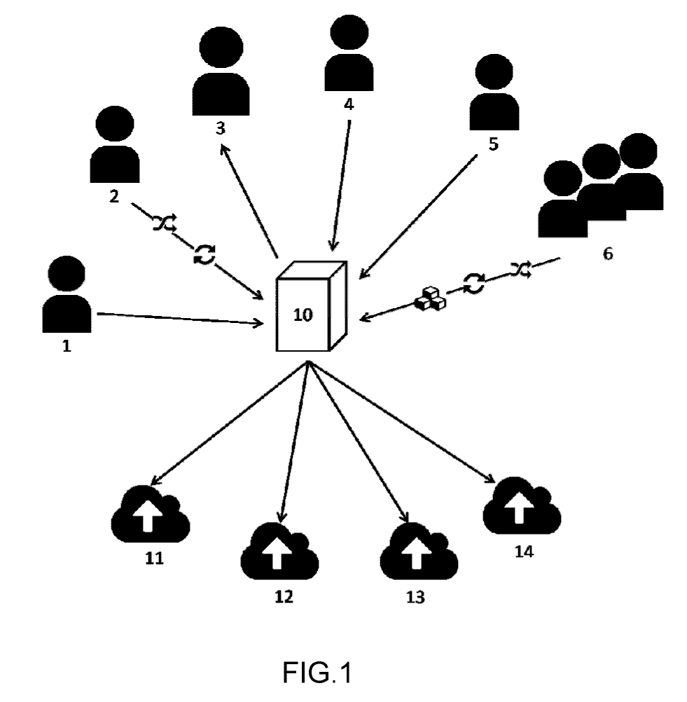

### DETAILED DESCRIPTION OF THE EMBODIMENTS

One aspect of the management of the life cycle of a Cloud application relates to its portability from one

Cloud infrastructure to another. For this purpose, the collaborative platform 10 takes into account the following requirements: the re-usability, the extendibility, the flexibility, the consistency, and the development/upgrade of the Cloud application.

In one embodiment, the management of the life cycle of a Cloud application includes:
the management of the version of the Cloud application;
the management of the environment and the adaptation of the Cloud resources
the integration of update policies;
the construction and the execution of certain functionalities; or
the integration of a functionality within an existing workflow.

The collaborative platform 10 for managing the life cycle of a Cloud application includes an abstraction of the relation between the Cloud application and the technical infrastructure supporting this Cloud application.

In this respect, the requirements of the Cloud application and its architecture in terms of infrastructure are modeled independently of the catalog of infrastructures of the Cloud providers. This modeling includes an abstraction of the relationships linking the deployment and the life cycle of the Cloud application to the languages and API specific to the Cloud infrastructures. This modeling thus allows the development of a Cloud application to be isolated/distinguished from the proprietary languages, from the execution infrastructures and from the deployment technologies.

In the collaborative platform 10 for managing the life cycle of a Cloud application, the components and the requirements of the Cloud application are of the TOSCA node type and modeled in the TOSCA format. These components are, furthermore, defined according to the TOSCA language. Advantageously, the TOSCA standard has come to the fore as a paradigm of choice
offering a common model for overcoming the problem of heterogeneity within Cloud infrastructures, and
allowing a movable deployment to any accommodating Cloud infrastructure, a fluid migration of the existing applications, and multi-cloud applications.

In one embodiment, the requirements of the Cloud application in terms of Cloud infrastructure are defined in the form of code (i.e. “Application as code”). This has the effect of facilitating the management of the life cycle of the application across a plurality of Cloud infrastructures.

The definition of the requirements of a Cloud application in a TOSCA format is carried out in a collaborative manner between the various players in the definition of the requirements, in terms of infrastructure, of a Cloud application. By way of example, these requirements may be expressed by the operational team 1, the middleware team 2, the director 3 of the information systems, the architect 4 of the Cloud application, the owner 5 of the Cloud application, the developers 6 of the Cloud application. The definition of the requirements in terms of Cloud infrastructure of the Cloud application implemented by the actors 1-6 is received by the collaborative platform 10.

A member of the operational team 1 may, for example, configure the Cloud application and the work spaces. A developer 5 of the Cloud application may, for example, establish customized application artifacts (such as scripts) or define application topologies. Similarly, a member of the middleware team 1 may establish and load a middleware application into the collaborative platform 10.

In one embodiment, the collaborative platform 10 allows the integration, via an appropriate interface (in other words, an API), of development functionalities for supplying a Cloud application with functionalities, and/or for specifying a certain environment for performing an end-to-end test of a certain functionality, while at the same time taking into account constraints of the Cloud application such as its continuous availability.

By way of examples, the platform 10 allows the following functionalities: the rationalization of the data processing system, the planning of the capacity of the application, the management of the middleware supports and their dates of expiration.

The functionalities loaded into the collaborative platform 10 may be designed for a development 11, for acceptance trials 12 (or UAT for User Acceptance Test), for a pre-production 13 or for a production 14 by the Cloud application.

The collaborative platform 10 brings together the management roles of the users in order to reinforce the collaboration for an improved management of the life cycle of the Cloud application. Advantageously, the platform 10 facilitates the collaboration between the developers and the deployment teams so as to take advantage of the competences of the various experts involved in the management of this Cloud application. An actor involved in the management of the Cloud application may, in particular, contribute and provide his/her contributions so as to reuse them in a simple and declarative manner. It accordingly follows that the collaborative platform 10 allows
a close collaboration between the deployment and development teams;
a management of the life cycle of a Cloud application; and
an administration of the Cloud infrastructure.

In one embodiment, the platform 10 further includes existing means for the orchestration and the execution of Cloud applications (such as the Cloudify tool, http://getcloudify.org).

The collaborative platform 10 allows the topologies of the Cloud applications, together with their deployment and their administration, to be managed for an improved visibility, an improved management of the life cycle, and an improved availability of the Cloud application.

The platform 10 supports a collaborative environment for the design, the management of the life cycle, and the administration of the application Cloud.

Advantageously, the collaborative platform 10 for managing the life cycle of a Cloud application endows this application with:
a multi-environment, multi-version, and multi-infrastructure aspect so as to facilitate its portability, notably via the TOSCA standard;
a flexible design with a composition exploiting predefined TOSCA models;
a customization of application environments.

The collaborative platform 10 advantageously allows
a link between an agile development environment and that of the deployment to be established so as to allow an end-to-end agility (or integrated agility);
a visibility over the life cycle of the application across the various Cloud environments.

1. A collaborative platform (10) for managing the life cycle of a Cloud application, comprising:
means configured for defining, in the form of code, a plurality of requirements, in terms of Cloud infrastructure, of the Cloud application.

2. The collaborative platform according to claim 1, further configured for integrating a development functionality in order to supply the Cloud application with functionalities.

3. The collaborative platform according to claim 1, in which the definition of the said plurality of requirements is carried out in a TOSCA format.

4. A method for managing the life cycle of a Cloud application, the method comprising:
defining, in the form of code, a plurality of requirements, in terms of Cloud infrastructure, of the Cloud application, and
receiving by a collaborative platform the definition, in the form of code, of the plurality of requirements.

5. The method according to claim 4, wherein the definition of the plurality of requirements is implemented in a TOSCA format.

6. A computer program product stored on a memory media, able to be implemented within a data processing unit and including instructions for the implementation of the method according to claim 4.

7. A computer program product stored on a memory media, able to be implemented within a data processing unit and including instructions for the implementation of the method according to claim 5.
